(19) United States
(12) Patent Application Publication
(10) Pub. No.: US 2009/0108988 A1
(43) Pub. Date: Apr. 30, 2009

(54) SYSTEM AND METHOD FOR ADMINISTERING ACCESS TO AN INTERIOR COMPARTMENT OF AN ENCLOSURE

(76) Inventors: Terri P. Cleveland, Holley, NY (US); Kelvin H. Wildman, Honeoye Falls, NY (US); Paul Magnant, Richmond, VT (US)

Correspondence Address: Woods Oviatt Gilman LLP, 700 Crossroads Bldg, 2 State St., Rochester, NY, 14614, US

(21) Appl. No.: 11/814,932

(22) PCT Filed: Jan. 27, 2006
(86) PCT No.: PCT/US06/03069

§ 371 Date: Apr. 7, 2008

Related U.S. Application Data
(60) Provisional application No. 60/647,638, filed on Jan. 27, 2005.

(51) Int. Cl. G06F 7/04; E05B 49/00

(52) U.S. Cl. 340/5.52; 340/5.54; 70/278.1; 70/278.2

(57) ABSTRACT

A system and method for administrating access to an interior compartment of a safe is provided. The safe includes a locking mechanism for locking and unlocking a safe door, and a lock interface including a biometric sensor, a keypad, and a memory. The interior compartment of the safe may be accessed using primary and secondary identification sequences, and primary and secondary unique identifying features. The manager initiates the safe using the pre-established master sequence and administrates the number of secondary users permitted to access the interior compartment of the safe. The pre-established master sequence may also be used to delete all identification sequences and unique identifying features that are stored in the lock interface. A key lock operates as a threshold or secondary lock that controls whether the primary and secondary identification sequences, and primary and secondary unique identifying features, may be used to unlock the locking mechanism.

### CROSS-REFERENCE TO RELATED APPLICATIONS

This application claims the benefit of U.S. Provisional Application No. 60/647,638, filed Jan. 27, 2005.

### BACKGROUND OF THE INVENTION

The present invention relates to a system and method for administering access to an interior compartment of an enclosure or safe. In particular, the present invention relates to a method and apparatus that uses either a primary unique identifying feature or a primary identification sequence to unlock a locking mechanism, thereby providing access to an interior compartment of the enclosure. In addition, the present invention provides a pre-established master sequence that may be used by a manager to store the primary identification sequence and primary unique identifying feature, allow one or more secondary users to store a secondary unique identifying feature and a secondary identification sequence, and remove unique identifying features and identification sequences stored in the system.

It is known to use a biometric safe lock for securing various types of enclosures. In particular, biometric safe locks may use a person's fingerprint to allow access to the interior compartment of a safe or other type of enclosure. In order to gain access to the interior compartment of the enclosure, a user places his or her finger on a fingerprint sensor, the biometric lock interprets the information gathered from the sensor and determines whether or hot the gathered fingerprint information is associated with an authorized user of the safe lock. If the safe lock does not recognize the information gathered by the sensor, it will deny access to the safe and the lock will remain in a locked position. If the lock recognizes the information gathered by the sensor, the locking mechanism is unlocked, thereby allowing the user to access the interior compartment of the safe.

However, the biometric locks that currently exist on safes include a number of drawbacks and deficiencies. For instance, some biometric safe locks do not provide any visual guidance to the user for properly positioning the fingerprint on the sensor. Improper finger positioning on the sensor makes it difficult for the sensor to properly read and interpret the user's fingerprint. If the sensor cannot read the fingerprint because of improper positioning, the lock will deny access to the user. This will require the user to manually unlock the safe using a key, which is typically the alternative method of opening the safe if the biometric entry is denied. However, it is not uncommon to misplace a key to a safe, which may further delay the user from accessing the interior compartment of the safe.

Even after the safe is opened using the biometric lock or the key lock, some existing biometric safe locks include an administrator button that is located on an interior portion of the safe. The administrator button is typically in an exposed location within the interior of the safe and may be used to add or delete one or more authorized fingerprints stored in the biometric lock. Given the exposed location of the administrator button within the safe, it may be utilized by either the manager or one of the secondary users the safe. Allowing the administrator button to be controlled by anyone with access to the safe is problematic since someone other than the manager or administrator could use the administrator button to erase all fingerprint information stored in the biometric lock and deny access to the manager and the other secondary users of the safe without the consent of the manager. Thus, unrestricted access to the administrator button may prevent the manager from having exclusive control over who has access to the safe.

Accordingly, there exists a need for a system and method for administering access to an interior compartment of an enclosure that provides multiple ways to unlock the locking mechanism that does not primarily rely on a key lock as an alternative method of entry. There is also a need in the art for a system and method for administering access to an interior compartment of the enclosure that prevents secondary users of the safe from erasing the stored fingerprint information and denying the manager and other secondary users access to the interior compartment of the safe without the consent of the manager. The present invention fills these needs as well as other needs.

### SUMMARY OF THE INVENTION

In order to overcome the above stated problems and limitations, there is provided a system and method for administrating access to the interior compartment of an enclosure or safe. The system and method of the present invention provides the option of using a unique biometric feature or entering a identification sequence or code using a keypad to access the interior compartment of the safe. In addition, the administrative system and method of the present invention does not allow secondary users to erase all of the fingerprints stored in the controller memory and thereby take control of the biometric lock.

In general, the safe includes a locking mechanism for locking and unlocking a door of the safe, a biometric sensor, a keypad, and a memory. The method of the present invention includes the steps of providing a pre-established master sequence stored in the memory, providing the ability to store a primary identification sequence in the memory using the keypad, and providing the ability to store a primary unique identifying feature in the memory using the biometric sensor. The primary identification sequence and primary unique identifying feature may be stored in the memory using the pre-established master sequence. The locking mechanism may be unlocked by at least one of a first input sequence or a first identifying feature. Specifically, if the first input sequence is provided using the keypad, the locking mechanism may be unlocked if the first input sequence matches the stored primary identification sequence. In addition, if the first identifying feature is provided using the biometric sensor, the locking mechanism may be unlocked if the first identifying feature matches the stored primary unique identifying feature.

The present invention also provides the ability to store a secondary identification sequence in the memory using the keypad, and provides the ability to store a secondary unique identifying feature in the memory using the biometric sensor. As such, the locking mechanism may be unlocked by using a second input sequence or a second identifying feature. In particular, if the second input sequence is provided using the keypad, the locking mechanism may be unlocked if the second input sequence matches the stored secondary identification sequence. If the second identifying feature is provided using the biometric sensor, the locking mechanism may be unlocked if the second identifying feature matches the stored secondary unique identifying feature.

Furthermore, the secondary identification sequence and the secondary unique identifying feature may be stored in the memory after at least one of the primary identification sequence or the primary unique identifying feature are stored in memory. The primary and secondary identification sequences, as well as the primary and secondary unique identifying features, may be deleted by entering the pre-established master sequence using the keypad. In addition, the safe may include a threshold lock, such as a key lock, wherein the locking mechanism may be unlocked by a identification sequence or unique identifying feature that matches a stored primary or secondary identification sequence or unique identifying feature only if the key lock is in an unlocked position.

### BRIEF DESCRIPTION OF THE SEVERAL VIEWS OF THE DRAWINGS

The above-mentioned and other features and advantages of this invention, and the manner of attaining them, will become apparent and be better understood by reference to the following description of one embodiment of the invention in conjunction with the accompanying drawings, wherein:

FIG. 1 is a front perspective view of a safe having a lock interface mounted to a door of the safe;

FIG. 2 is a schematic view of the lock interface shown in FIG. 1;

FIG. 3 is a flow chart showing the operation of a portion of the administrative system of the present invention when a manager enters a pre-established master sequence, primary identification sequence and a primary unique identifying feature;

FIG. 4 is a flow chart showing the operation of a portion of the administrative system of the present invention when the manager adds or deletes a secondary user from the system;

FIG. 5 is a flow chart showing the operation of a portion of the administrative system of the present invention when the pre-established master sequence is used to erase all of the identification sequences and unique identification sequences from the system;

FIG. 6 is a flow chart showing the operation of a portion of the administrative system where the manager adds one or more of the primary unique identification sequences;

FIG. 7 is a flow chart showing the operation of a portion of the administrative system of the present invention when the manager or secondary user attempts to unlock the safe;

FIG. 8 is a perspective view of a rear portion of the safe door shown in FIG. 1, wherein the back cover of the door is removed to show a live bolt system;

FIG. 9 is a front view of one alternative embodiment of the lock interface;

FIG. 10 is a perspective view of a portion of the lock interface shown in FIG. 9;

FIG. 11 is a front view of the portion of the lock interface shown in FIG. 10;

FIG. 12 is a top view of the portion of the lock interface shown in FIG. 10; and

FIG. 13 is a right side view of the portion of the lock interface shown in FIG. 10.

### DETAILED DESCRIPTION OF THE INVENTION

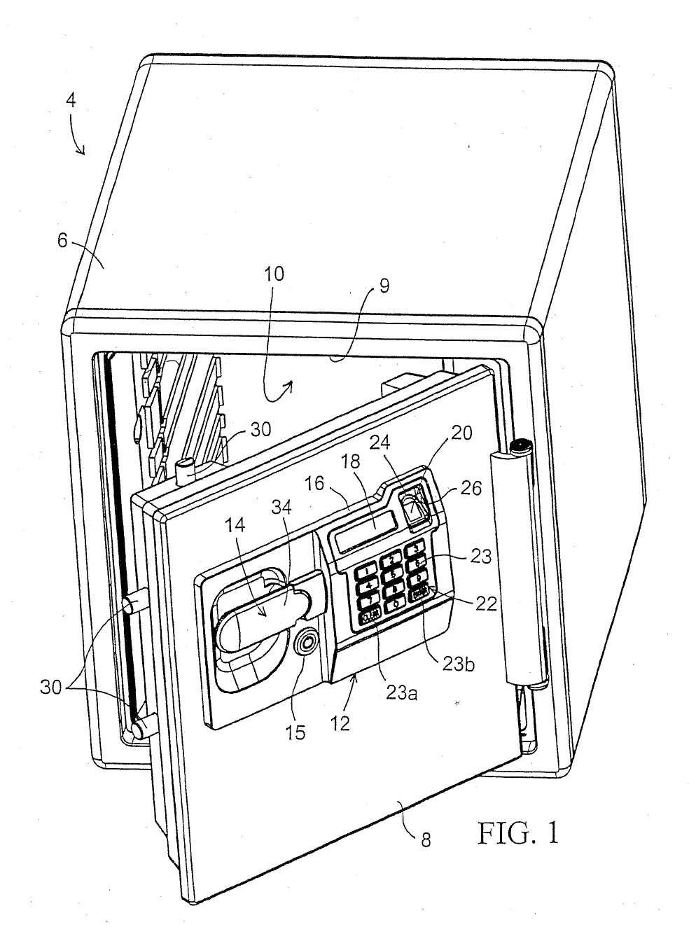

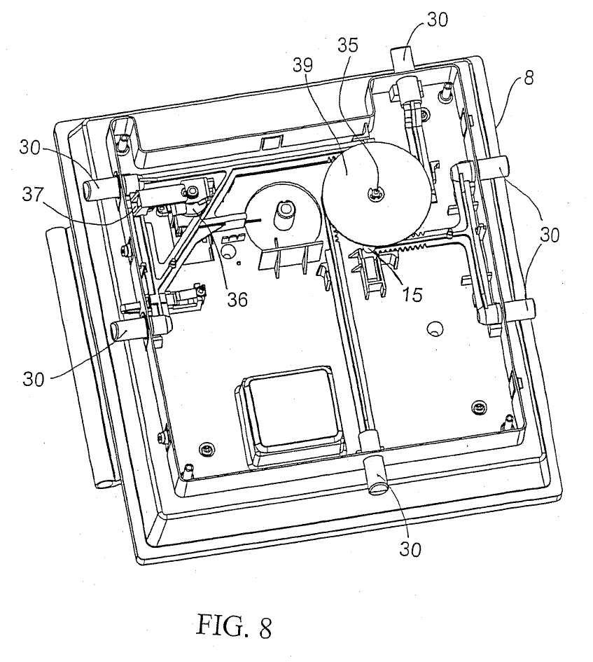

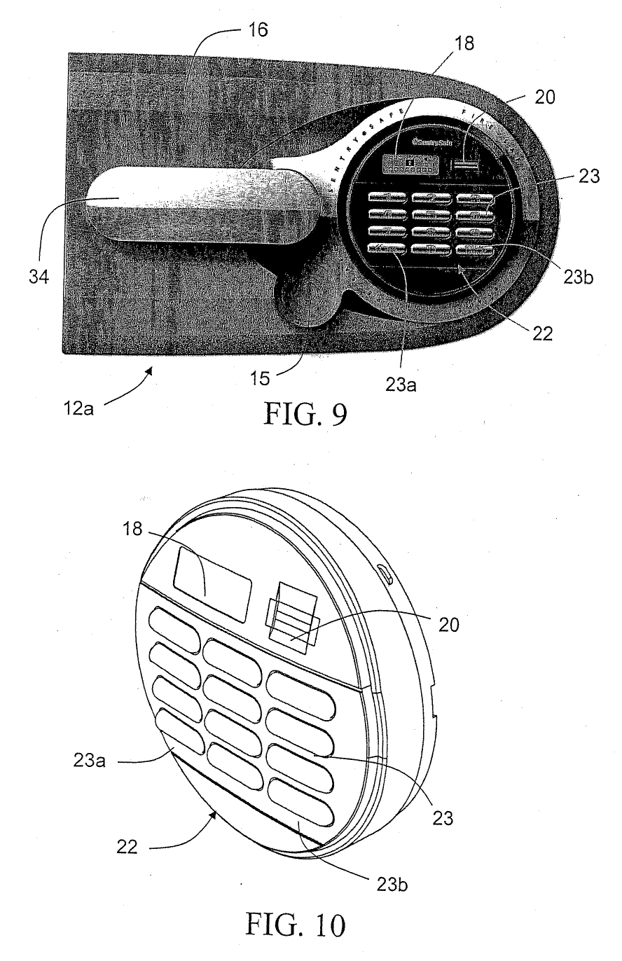

Referring to the drawings in detail, and particularly FIG. 1, there is shown a safe or enclosure 4 having a housing 6 and a door 8 that is hingedly connected thereto. The housing 6 includes an opening 9 that provides access to an interior compartment 10 defined by housing 6. Door 8 has a lock interface 12 mounted thereon, which operates to administrate access to internal compartment 10 of safe 4. It should be understood that any discussion related to lock interface 12 also applies to a lock interface 12a shown in FIG. 9.

In general, at least one of a unique identifying feature, such as a fingerprint, or an identification sequence, such as a numerical code, may be entered using the lock interface 12, 12a. Lock interface 12, 12a compares the entered unique identifying feature or identification sequence with information stored in the lock interface 12, 12a, and unlocks a locking mechanism 14 to provide access to interior compartment 10 of safe 4 if the entered information matches the stored information. In addition, the present invention provides a pre-established master sequence that may be used by a manager to store a primary identification sequence and primary unique identifying feature, allow one or more secondary users to store a secondary unique identifying feature and a secondary identification sequence, and remove one or more unique identifying features and identification sequences stored in lock interface 12, 12a. Furthermore, a key lock 15 may be used as a threshold lock to control whether the locking mechanism 14 may be unlocked using the primary or secondary identification sequences or primary or secondary unique identifying features to allow access to interior compartment 10.

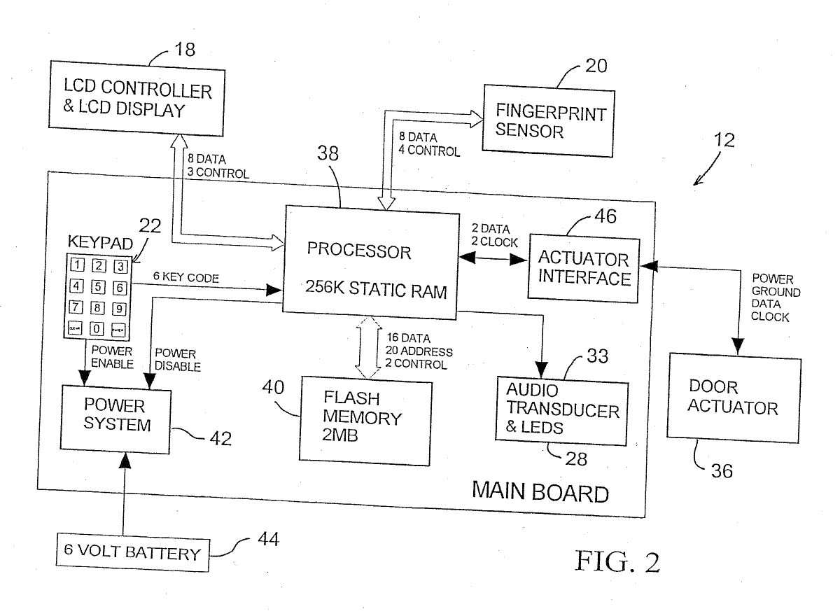

As best see in FIGS. 1 and 9, lock interface 12, 12a generally includes a body or escutcheon plate 16 that is mounted to door 8 of safe 4. Lock interface 12, 12a may also include a display 18, a biometric sensor 20, and a keypad 22. Further, lock interface 12 may include a transparent surface 24 located within a recess 26 and one or more transparent keypad buttons 23 that allow light emitted from one or more backlight Light Emitting Diodes (LED's) 28 (FIG. 2) to pass therethrough. The light passing through surfaces 24 and keypad buttons 23, in conjunction with display 18, may provide the user with visual cues to assist in operating lock interface 12.

Lock interface 12 may also include a biometric alignment feature (not shown) that is positioned relative to biometric sensor 20 to guide the user in properly positioning his or her unique identifying characteristic, such as a fingerprint, in an acceptable location on biometric sensor 20. Biometric alignment feature may include one or more crosshairs that are positioned in recess 26 to identify an acceptable target area for a user to place the thick or pad portion of his or her fingerprint on biometric sensor 20 so that biometric sensor 20 is able to read the fingerprint. In particular, crosshairs may be aligned with each other, extend vertically, and be positioned on opposite sides of biometric sensor 20, wherein one crosshair is positioned above the top boundary of the sensor 20 and the other crosshair is positioned below the bottom boundary of the sensor 20. Crosshairs may be aligned with each other, extend horizontally, and positioned on opposite sides of biometric sensor 20, wherein one crosshair is positioned to the left of the left boundary of the sensor 20 and the other crosshair is positioned to the right of the right boundary of the sensor 20. It will be understood and appreciated that biometric alignment feature may take other forms so long as the feature directs the user to properly position his or her unique identifying feature on biometric sensor 20 so that an adequate reading can be taken.

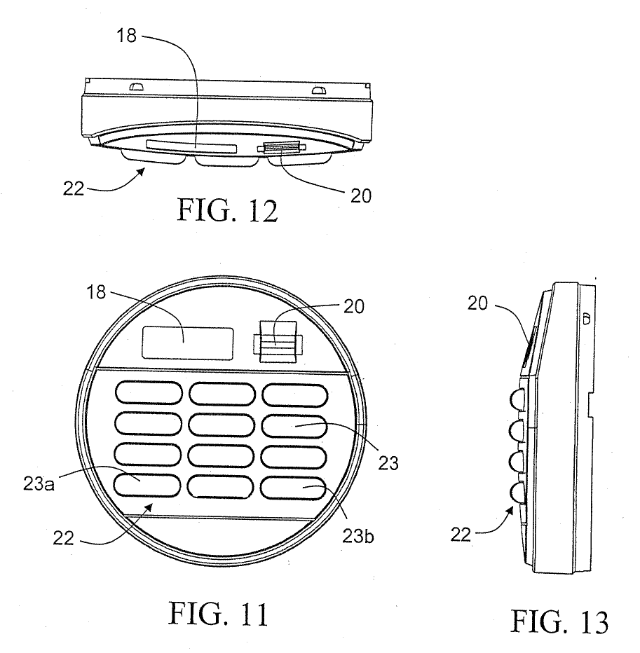

Lock interface 12, 12a may use fingerprint identification, such as a unique identifying feature or characteristic, to unlock the safe. Therefore biometric sensor 20 may be either a capacitance or optical fingerprint sensor, such as a FUJITSU® MBF200 Capacitive Sensor (FIG. 1) or a swipe fingerprint sensor, such as a FUJITSU® MBF310 Solid State Fingerprint Sweep Sensor (FIGS. 9-13). While a person's fingerprint may be used as the unique identifying feature that will unlock locking mechanism 14, it will be understood that any unique identifying living or human characteristic, such as, but not limited to voice recordings, irises, facial images and the like may be read by biometric sensor 20. Also, the recess 26 formed in escutcheon plate 16 may be constructed in such a way that biometric sensor 20 is angled upwardly relative to door 8 of safe 4 so it is easier for a user to place his or her finger on biometric sensor 20.

Display 18 may be a Liquid Crystal Display (LCD) screen that is adapted to provide visual clues or prompts to provide a user with instructions or information while operating lock interface 12. The types of instructions or information that may be provided on display 18 include text prompts or symbols to provide a user with directions to a user, a battery level indicator that informs the user of the power remaining in the system, and other information. Likewise, the visual cues provided to a user by the background LED's 28 that selectively emit light on lock interface 12 also provide direction to a user as to what steps are required to proceed with either gaining access to the safe, or to add or delete information from lock interface 12. As best seen in FIG. 2, an audio transducer 33 may also be included to provide audible indicators to the user.

As best seen in FIGS. 1 and 9, keypad 22 may include keypad buttons 23 that allow a user to input a code or sequence, such as a primary identification sequence, a secondary identification sequence or a pre-established master sequence. In particular, with additional reference to FIG. 2, keypad buttons 23 may be marked with numeric symbols such as the numbers 0-9, a clear key 23a, and an enter key 23b. It will be understood and appreciated that keypad buttons 23 on keypad 22 may also be labeled with other types of symbols such as letters.

As best seen in FIGS. 1, 8 and 9, locking mechanism 14 operates in association with lock interface 12, 12a to unlock and lock the door 8 of the enclosure. Locking mechanism 14 may be a live bolt system that includes one or more live bolts 30, a handle 34 coupled with a spindle 35, and a drive gear 39. Live bolts 30 may be movably mounted to door 8 and operate to selectively secure door 8 with housing 6 of safe 4 to prevent door 8 from being opened relative to housing 6. Handle 34 and spindle 35 are coupled with live bolts 30 by drive gear 39 and may be used to move live bolts 30 between locked and unlocked positions by rotating handle 34, spindle 35 and drive gear 39 relative to door 8. With additional reference to FIG. 2, an actuator or solenoid 36 is mounted to the door 8 and includes a tab 37 that may be positioned to block the movement of live bolts 30 to an unlocked position when solenoid 36 is not energized. When solenoid 36 is energized, tab 37 moves to a position to allow live bolts 30 to be moved to the unlocked position by rotating handle 34.

As best seen in FIGS. 1, 8 and 9, key lock 15 may be used as a threshold lock to control whether locking mechanism 14 may be unlocked using the primary or secondary identification sequences, or the primary or secondary unique identifying features. In other words, if key lock 15 is in a locked position, key lock 15 will prevent live bolts 30 from moving to an unlocked position regardless of whether the inputted sequence matches the stored primary or secondary identification sequences, or the inputted identifying feature matches the stored primary or secondary unique identifying features. Key lock 15 essentially operates as a secondary or threshold lock that provides a second level of security for the safe. In order to access interior compartment 10 of the safe, key lock 15 must be in an unlocked position, which will allow live bolts 30 to be disengaged with housing 6 if the inputted sequence matches the stored primary or secondary identification sequences, or if the inputted identifying feature matches the stored primary or secondary unique identifying features.

As best seen in FIG. 2, lock interface 12, 12a includes a processor 38 that is connected to, in addition to other components, display 18, biometric sensor 20, and keypad 22. Processor 38 is operable to perform tasks or instructions in accordance with pre-programmed algorithms, execution instructions or sequences, computations, software code modules, interface specifications or the like in order to administrate access to safe 4. It will be understood and appreciated that the functions performed by processor 38 may be implemented in an environment such as lock interface 12, 12a, a personal computer (PC) or other device that operates to administrate access to interior compartment 10 of safe 4. Lock interface 12, 12a may also include a storage device 40 including volatile and nonvolatile, removable and non-removable media implemented in any method or technology for storing information such as program modules, data structures, computer readable instructions, or other data.

The storage device 40 may be a computer-readable medium and include any type of memory including, but not limited to, floppy disks, conventional hard disks, Read Only Memory (ROM), Random Access Memory (RAM), flash memory, Electrically Erasable Programmable Read-Only Memory (EEPROM), or other types of memory, magnetic cassettes, magnetic tape, magnetic disk storage or other magnetic storage devices, CD-ROM, digital versatile disks (DVD) or other optical disk storage, or any other medium which can be used to store the desired information and which can be accessed by processor 38.

Processor 38 may also include communication media for sending and receiving signals, instructions or other parameters from other components in the administrative system, such as display 18, biometric sensor 20, keypad 22, and an actuator interface 46. Communication media typically embodies computer readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a direct wired connection, and wireless media such as acoustic, RF, infrared and other wireless media. It will be understood that combinations of any of the above should also be included within the scope of computer readable media.

Processor 38 may also communicate with a personal computer (PC) that includes a database or other system that logs, stores or otherwise maintains a record in memory of who has accessed or attempted to access the safe using lock interface 12. In particular, the PC may store any identification sequences or unique identifying features that were inputted using lock interface 12 in order to monitor the use of the safe.

As best seen in FIG. 2, a power system 42 is connected to processor 38 and controls the power being supplied by a battery 44 to the components of lock interface 12, 12a. Keypad 22 is also connected to power system 42. Processor 38 is also connected to audio transducer 33 and LED's 28 that selectively illuminate the keys on the keypad 22 and transparent surface 24 positioned within recess 26 adjacent to biometric sensor 20. Actuator interface 46 is connected with processor 38 and receives instructions from processor 38 to either lock or unlock locking mechanism 14. Actuator interface 46 then sends a lock or unlock signal to door actuator or solenoid 36 in accordance with the instructions received from processor 38 to selectively allow live bolts 30 to be moved between locked and unlocked positions using handle 34.

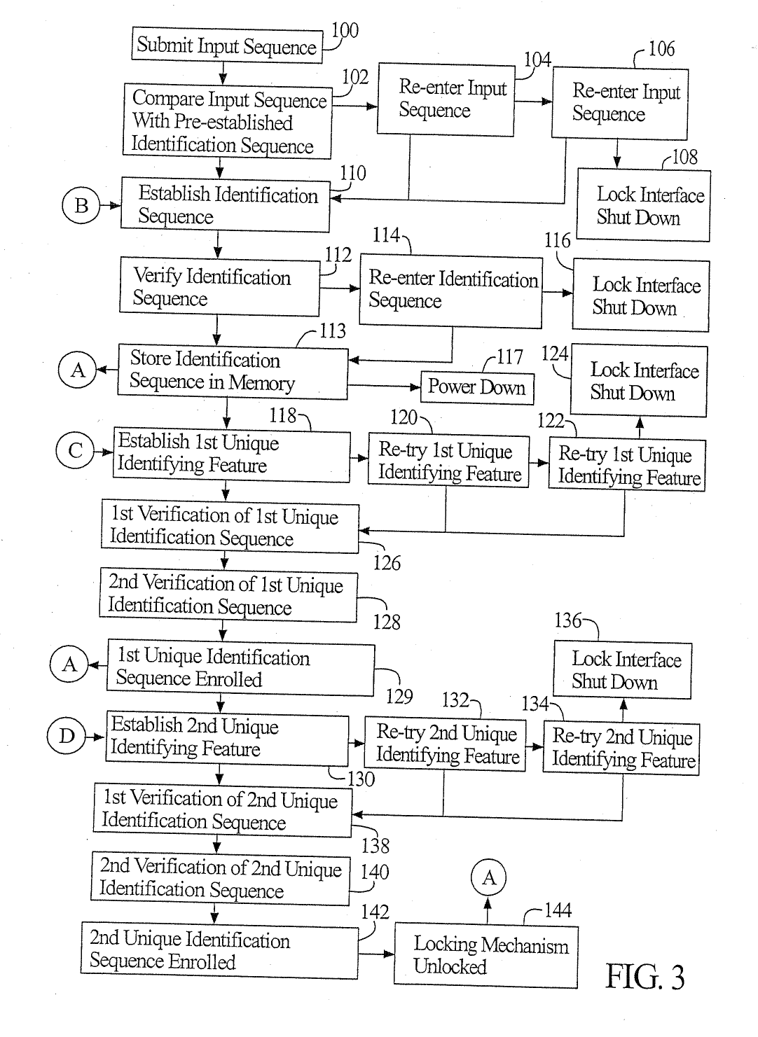

Processor 38 operates to maintain in storage device 40 a pre-established master sequence or factory code that may be established or stored by the manufacturer of the safe before the system is initiated or first used by a manager. The pre-established master sequence may be permanent and securely maintained by the manufacturer or a third-party so that an authorized primary user can at a later time access the pre-established master sequence to program lock interface 12, 12a as best seen in FIGS. 3, 5 and 6. In addition, processor 38 may also maintain in storage device 40 at least one primary identification sequence or manager code, and at least one secondary identification sequence or user code that are entered into the system using keypad 22. Each of the pre-established master sequence, primary identification sequence, and secondary identification sequence may be five digit numbers, but it will be understood that more or less digits may be used to establish each of the aforementioned sequences. Furthermore, processor 38 may also maintain in the memory of storage device 40 at least one primary unique identifying feature or manager fingerprint, and at least one secondary unique identifying feature or user fingerprint that are entered or submitted into the system using biometric sensor 20.

In making the determination of whether to unlock the locking mechanism 14, processor 38 is programmed to compare an input sequence entered into keypad 22 with the stored primary identification sequence, secondary identification sequence, and the pre-established master sequence and unlock the locking mechanism 14 if the input sequence matches at least one of the stored primary identification sequence and the secondary identification sequence. Also, if an identifying feature is entered or submitted using biometric sensor 20, processor is programmed to compare the entered identifying feature with the stored primary unique identifying feature and the secondary identifying feature and unlock locking mechanism 14 if the entered identifying feature matches at least one of the stored primary unique identifying feature and the secondary identifying feature.

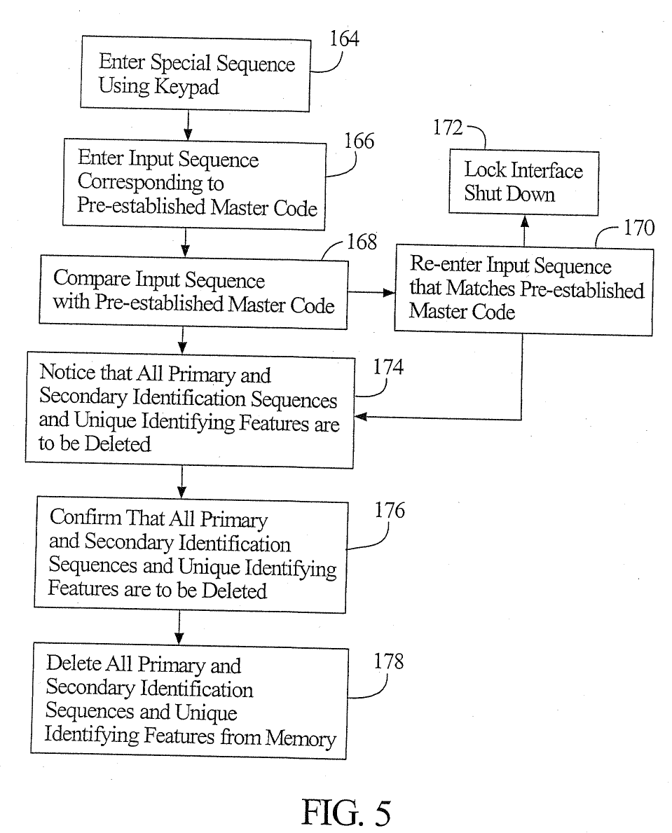

Processor 38 also allows for the deletion of one or more of the stored primary identification sequence, primary unique identifying feature, secondary identification sequence, or secondary unique identifying feature from storage device 40 by entering the pre-established master sequence using keypad 22. The deletion of one or more of primary identification sequence, primary unique identifying feature, secondary identification sequence, or secondary unique identifying feature will be discussed in more detail below with reference to FIG. 5.

The lock interface 12, 12a may store one or more fingerprints for one manager and six secondary users that are permitted access to interior compartment 10 of safe 4. A manager not only has the ability to gain access to safe 4 by using the primary identification sequence and the primary unique identifying feature, the manager also has the authority to add and delete secondary users from the memory of lock interface 12, 12a, as noted above. The secondary users of lock interface 12, 12a may gain access to the safe by using his or her secondary identification sequence and secondary unique identifying feature. However, the secondary users are not able add or delete any other secondary users or managers, unless one of the secondary users has access to the pre-established master sequence. The manager and secondary users may be required to store two fingerprints (e.g., thumb and index fingerprint) to gain access to the safe. However, it will be understood that more or less fingerprints may be required depending at least in part on the desired level of security for the safe. Further, it is within the scope of the present invention to include any number of managers or secondary users in the administrative system of the present invention.

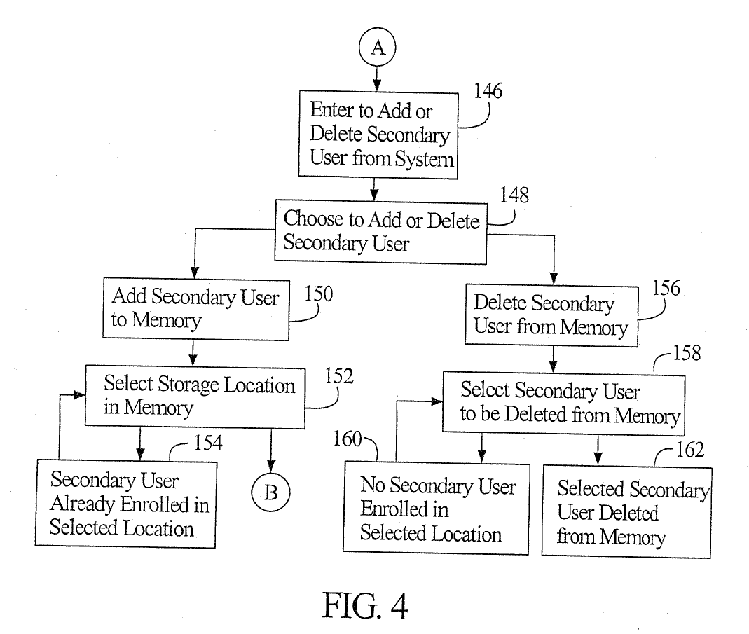

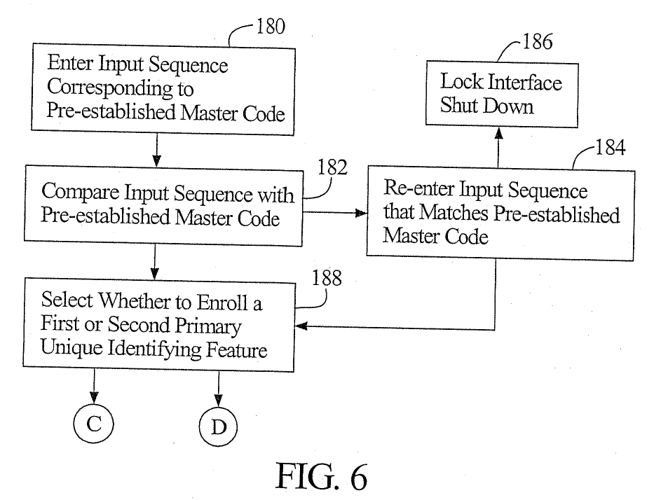

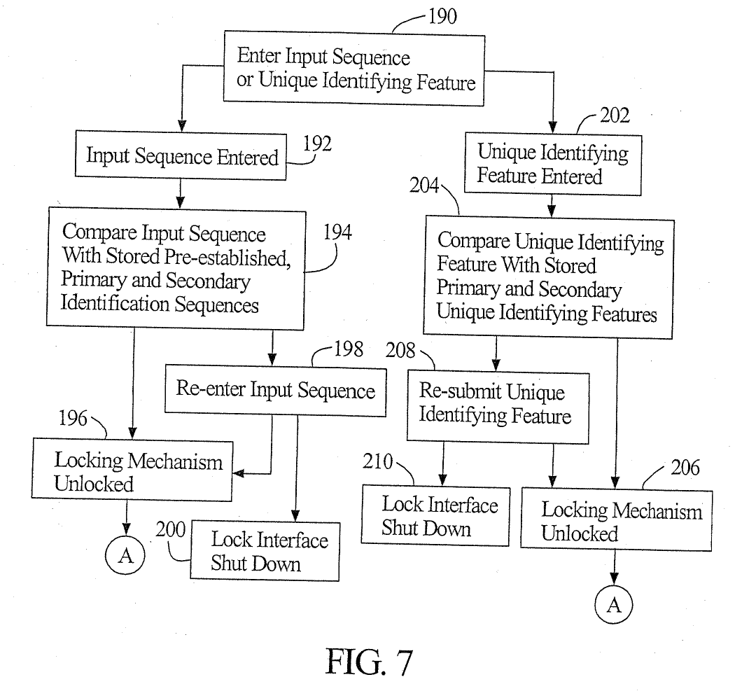

The administrative system of the present invention provides a system and method that allows the manager to set up the lock interface 12, 12a (FIG. 3), enroll or delete one or more identification sequences and unique identifying features from lock interface 12, 12a (FIG. 4), delete all of the identification sequences and unique identifying features from lock interface 12, 12a using the pre-established master sequence (FIG. 5), add a primary identification feature after the initial set up of the administrative system (FIG. 6), and unlock the locking mechanism 14 using lock interface 12, 12a (FIG. 7). Furthermore, during an attempt to setup, unlock, or add or delete one or more identification sequences and unique identifying features using the administrative system of the present invention, lock interface 12, 12a may provide the user with visual cues, such as written information on display 18 and prompt LED's 28 and audio cues using audio transducer 33, to assist and provide the user with instructions for operating the system. Moreover, the present invention may include a computer-readable medium having computer-executable instructions for performing the method shown and described in FIGS. 3-7, which will be described in more detail below.

As best seen in FIG. 3, lock interface 12, 12a may undergo a series of steps when the manager attempts to set up lock interface 12, 12a using the administrative system. In particular, step 100 shows that the manager may enter or submit an input sequence, that matches the pre-established master sequence or factory code that was provided with safe 4 upon purchase or by a third party who securely maintains the pre-established code, using keypad 22. The pre-established master sequence may be a five digit number or any other type of code. The input sequence is submitted using keypad 22, and the input sequence is communicated to processor 38, wherein processor 38 compares the input sequence with the pre-established master sequence at step 102. If the input sequence does not match the pre-established master sequence, the system moves to step 104 so that the input sequence can be re-entered. If the input sequence is re-entered and still does not match the pre-established master sequence, the system moves to step 106, so that the input sequence can be re-entered a third time. If the input sequence is re-entered again and still does not match the pre-established master sequence, the system is shut down at step 108. However, if the input sequence matches the pre-established master sequence stored in memory 40 at steps 102, 104, 106, then the system proceeds to allow the manager to establish a primary user identification sequence or manager code at step 110.

The manager then selects a primary user identification sequence using keypad 22 and verifies the code at step 112. If the verification of the primary user identification sequence fails, the system allows the manager to retry the verification of the primary user identification sequence at step 114. If the verification of the primary user identification sequence fails at step 114, then the system is shut down at step 116. On the other hand, if the verification of the primary user identification sequence at either step 112, 114 is successful by matching the previously entered primary user identification sequence with the verified primary user identification sequence stored in memory 40, then the system stores the primary user identification sequence in memory 40 at step 113 to allow the manager to gain access to the internal compartment of the enclosure using the primary user identification sequence. At that point, the system proceeds to allow the manager to either shut down lock interface 12 at step 117, establish a first primary unique identification feature or manager fingerprint at step 118, or proceed to step 146, as best seen in FIG. 4, which allows the manager to enroll or delete one or more secondary identification sequences and secondary unique identifying features from lock interface 12. The sequence of events shown in FIG. 4 will be described in more detail below.

In proceeding to discuss the sequence of events shown in FIG. 3, the manager may decide to enter his or her first primary unique identification feature, such as a fingerprint, using biometric sensor 20 at step 118. If the biometric image obtained by biometric sensor 20 is not readable or is considered to be a bad image by processor 38, the system requests that the first primary unique identification feature be placed on biometric sensor or swiped again at step 120. If the image is once again not readable or is considered a bad image by processor 38, the system requests that the first primary unique identification feature be placed on biometric sensor or swiped again at step 122. The system is shut down at step 124 if another bad image is obtained by biometric sensor 20 and the user is instructed to clean biometric sensor 20 using display 18. However, if biometric lock 20 is able to read the biometric feature in steps 118, 120, 122, the system proceeds to a first and second verification process in steps 126, 128. During the verification process in steps 126, 128, the manager places or swipes his or her first primary unique identification feature using biometric sensor 20 as was done in step 118 and processor 38 verifies if the subsequent fingerprint matches the previously entered first primary unique identification feature. If the biometric image obtained by biometric sensor 20 in steps 126, 128 is not readable or is considered a bad image by processor 38, the system may request that the first unique identification feature be placed on or swiped using biometric sensor again, just as was described in steps 120, 122 and shut down as in step 124 if the processor 38 continues to receive bad biometric images. A successful second verification of the first primary unique identification feature at step 128 enrolls the first primary unique identification feature in memory 40 at step 129. Further, a successful enrollment of the first primary unique identification feature allows the manager to either establish a second primary unique identification feature at step 130, or proceed to step 146, as best seen in FIG. 4, which allows the manager to enroll or delete one or more secondary identification sequences and secondary unique identifying features from lock interface 12, 12a.

In proceeding to discuss the sequence of events shown in FIG. 3, the manager may decide to enter his or her secondary primary unique identification feature, such as a fingerprint, using biometric sensor 20 at step 130. If the biometric image obtained by biometric sensor 20 is not readable or is considered a bad image by processor 38, the system requests that the second primary unique identification feature be placed on or swiped using biometric sensor again at step 132. If the image is once again not readable or is considered a bad image by processor 38, the system requests that the second primary unique identification feature be placed on or swiped using biometric sensor again at step 134. If another bad image is obtained by biometric sensor 20 the user is told to clean biometric sensor 20 on display 18 and the system is shut down at step 136. However, if biometric lock 20 is able to read the biometric feature in steps 130, 132, 134, the system proceeds to a first and second verification process in steps 138, 140. During the verification process in steps 138, 140, the manager places or swipes his or her second primary unique identification feature using biometric sensor 20 as was done in step 130 and processor 38 verifies if the subsequent fingerprint matches the previously entered second primary unique identification feature. If the biometric image obtained by biometric sensor 20 in steps 138, 140 is not readable or is considered a bad image by processor 38, the system may request that the second unique identification feature be placed on or swiped using biometric sensor again, just as was described in steps 132, 134 and shut down as in step 136 if the processor 38 continues to receive bad biometric images. A successful second verification of the second primary unique identification feature at step 140 enrolls the second primary unique identification feature in the processor 38 at step 142. Upon the successful second verification of the second primary unique identification feature, processor 38 sends a signal to actuator 36 through actuator interface 46 to allow locking mechanism 14 to be unlocked at step 144 thereby allowing access to interior compartment 10 of safe 4, but only if key lock 15 is in the unlocked position. Furthermore, the manager may proceed to step 146, as best seen in FIG. 4, which allows the manager to enroll or delete one or more secondary identification sequences and secondary unique identifying features from lock interface 12, 12a.

As best seen in FIG. 4, the manager may enroll or delete one or more secondary identification sequences or secondary unique identifying features from memory 40 beginning at step 146. First, the manager may initiate the enrollment or deletion of a secondary user by pressing an indicated keypad button 23 on keypad 22 to proceed to step 148. At step 148, the manager has to choose whether to either add or delete a secondary user from memory 40. If the manager chooses to enroll or add a secondary user at step 150, then the manager may choose the memory location which the secondary user will be stored at step 152. If a secondary user is already stored in the selected memory location at step 154, then the system returns to step 152. On the other hand, if a secondary user is not stored in the selected memory location, then the system proceeds from step 152 to step 110 in FIG. 3 to allow a secondary user or manager to establish one or more secondary user identification sequences or user codes.

Returning to step 148 in FIG. 4, the manager or primary user may choose to delete a unique identifying feature of a secondary user from memory 40. If the manager chooses to delete a secondary user at step 156, then the manager may choose the memory location which the secondary user will be stored at step 158. If a secondary user is not stored in the selected memory location at step 160, then the system returns to step 158. On the other hand, if a secondary user is stored in the selected memory location, then the system proceeds from step 158 to step 162 and deletes the identification sequences and unique identifying features associated with that particular secondary user from memory 40.

As best seen in FIG. 5, the pre-established master sequence may be used to delete all of the identification sequences and unique identifying features from memory 40. At step 164, a special sequence is entered using keypad 22, such as “99”, the clear button 23a, “2004” and then the enter button 23b. It will be understood that other alpha-numeric sequences may be used as the aforementioned special sequence. Next, an input sequence must be entered into the system using keypad 22 that matches the pre-established master code at step 166. The processor 38 then compares the input sequence with the pre-established master code stored in memory 40 at step 168. If the input sequence does not match the pre-established master sequence, the system requests that the input sequence be re-entered at step 170. The lock interface 12, 12a is shut down at step 172 if the input sequence does not match the pre-established master sequence on the second try. If the input sequence matches the pre-established master sequence at either of steps 168, 170, then the system inquires or provides notice that all primary and secondary identification sequences and unique identifying features will be deleted from memory 40 at step 174. Once the manager requests that all primary and secondary identification sequences and unique identifying features should be deleted from memory 40, the system confirms that such information should be deleted from memory 40 at step 176. At step 178, once the manager confirms that all primary and secondary identification sequences and unique identifying features should be deleted, the system deletes this information from memory 40 and essentially is a new unit capable of beginning operation from step 100 in FIG. 3.

During the setup of the administrative system, the manager may have decided to shut down the lock interface 12, 12a at step 117 in FIG. 3. Therefore, the only way the manager can access interior compartment 10 of safe 4 is by entering the primary identification sequence established in steps 110, 112, 113. The flow chart shown in FIG. 7 may be used when the manager enrolled a primary identification sequence at step 113 and then shut down the lock interface 12, 12a at step 117 without enrolling the primary unique identification feature in memory 40. First, as best seen in FIG. 6, an input sequence may be entered into the system using keypad 22 that matches the pre-established master code at step 180. The processor 38 then compares the input sequence with the pre-established master code stored in memory 40 at step 182. If the input sequence does not match the pre-established master sequence, the system requests that the input sequence be re-entered at step 184. The lock interface 12, 12a is shut down at step 186 if the input sequence does not match the pre-established master sequence on the second try. If the input sequence matches the pre-established master sequence at either of steps 182, 184, then the system inquires as to whether the first or second primary unique identifying features should be stored in memory 40 at step 188. If the first primary unique identifying features is to be stored in memory 40, then the system proceeds to step 118 shown in FIG. 1. If the second primary unique identifying features is to be stored in memory 40, then the system proceeds to step 130 shown in FIG. 1.

The manager or secondary user may attempt to unlock the locking mechanism 14 as shown in FIG. 7. However, before the primary or secondary identification sequence, or primary or secondary unique identification sequence, may be used to gain access to interior compartment 19, it must be determined whether key lock 15 is in a locked or unlocked position. If key lock 15 is in a locked position, live bolts 30 may not be disengaged with housing 6 to allow access to interior compartment 10 even if an inputted identification sequence matches a stored primary or secondary identification sequence, or if an inputted unique identifying feature matches a stored primary or secondary unique identifying sequence. On the other hand, if key lock 15 is in an unlocked position, the primary or secondary identification sequences, or the primary or secondary unique identifying features, may be used to disengage live bolts 30 with housing 6 thereby allowing access to interior compartment 10.

As such, if key lock 15 is in an unlocked position, the first step in gaining access to internal compartment 10 is shown in step 190 where the system requests that an input sequence be entered using keypad 22 or that an identifying feature be entered using biometric sensor 20. If an input sequence, such as a five digit number, is entered using keypad 22 at step 192, then processor 38 compares the input sequence with the stored primary and secondary identification sequences at step 194. If the input sequence matches at least one of the stored primary or secondary identification sequences, then solenoid 36 is activated by processor 38 through actuator interface 46 allowing the locking mechanism 14 to be moved to an unlocked position using handle 34 at step 196. In particular, solenoid 36 operates to move tab 37 to a position that allows live bolts 30 to be disengaged with housing 6 and allow door 8 to be opened. In the circumstance where the input sequence matches the primary identification sequence, the system may move to step 146 in FIG. 4. As best seen in FIG. 7, if the input sequence does not match the stored primary or secondary identification sequences at step 194, then the system requests that the input sequence be re-entered using keypad 22 at step 198. If the input sequence then matches at least one of the stored primary or secondary identification sequences, then solenoid 36 is activated by processor 38 through actuator interface 46 allowing the locking mechanism 14 to be moved to an unlocked position at step 196. However, lock interface 12, 12a shuts down at step 200 if the input sequence does not match the stored primary or secondary identification sequences on the second try.

Referring back to step 190, the user may also choose to use a unique identifying feature to unlock the enclosure to gain access to interior compartment 10 of safe 4. At step 194, the unique identifying feature is submitted using biometric sensor 20 at step 202. The submitted unique identifying feature is compared by processor 38 with stored unique primary and secondary identifying features at step 204. If the submitted identifying feature matches at least one of the stored unique primary and secondary identifying features, then solenoid 36 is activated by processor 38 through actuator interface 46 allowing the locking mechanism 14 to be moved to an unlocked position using handle 34 at step 206. Specifically, solenoid 36 operates to move tab 37 to a position that allows live bolts 30 to be disengaged with housing 6 and allow door 8 to be opened. In the circumstance where the submitted identifying feature matches the primary identifying feature, the system may move to step 146 in FIG. 4. If the submitted unique identifying feature does not match at least one of the stored unique primary or secondary identifying features, or is not readable by biometric sensor 20 or processor 38, or considered a bad image, at step 204, then the system requests that the submitted unique identifying feature be re-entered using biometric sensor 20 at step 208. If the submitted unique identifying feature then matches at least one of the stored primary or secondary unique identifying features, then solenoid 36 is actuated by processor 38 through actuator interface 46 allowing the locking mechanism 14 to be moved to an unlocked position at step 206. However, lock interface 12, 12a shuts down at step 210 if the subsequent submitted unique identifying feature does not match the stored primary and secondary unique identifying features or is not readable by biometric sensor 20 or processor 38, or considered a bad image, on the second try. It will be understood that the submitted unique identifying features may be entered into the system more than two times before the lock interface shuts down at step 210, if desired.

The present invention overcomes and ameliorates the drawbacks and deficiencies in the prior art. The present method does not rely on a key lock as the method of accessing the safe if the biometric entry is denied. Instead, the present invention provides the option of using a unique biometric feature or entering a identification sequence or code using a keypad to access the interior compartment of the safe. Furthermore, the administrative system and method of the present invention uses a pre-established master sequence to set up the safe and erase all of the fingerprints stored in the controller memory, which prevents the secondary users from taking control of the biometric lock. The present invention also includes a threshold lock, such as a key lock, that serves as a secondary lock that controls whether the primary and secondary identification sequences, and the primary or the primary and secondary unique identifying features, may be used to open the safe.

Although the present invention has been described in considerable detail with reference to certain preferred versions thereof, other versions are possible. Therefore, the spirit and scope of the appended claims should not be limited to the description of the preferred versions contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

1. A method for administering access to an interior compartment of an enclosure, wherein the enclosure includes a locking mechanism for locking and unlocking a door of the enclosure, a biometric sensor, a keypad, and a memory, the method comprising:
providing a pre-established master sequence stored in the memory;
providing the ability to store a primary identification sequence in the memory using the keypad; and
providing the ability to store a primary unique identifying feature in the memory using the biometric sensor, wherein the locking mechanism is unlocked by
providing a first identifying feature using the biometric sensor that matches the primary unique identifying feature, and if access to the interior compartment is denied after providing the first identifying feature, allowing the locking mechanism to be unlocked by entering a first input sequence using the keypad that matches the primary identification sequence.

2. The method of claim 1, further comprising mounting the biometric sensor and the keypad to the door of the enclosure.

3. The method of claim 1, wherein the primary identification sequence is a five digit number.

4. The method of claim 1, wherein the pre-established master sequence is securely maintained by a third-party, and wherein a primary user is provided access to the pre-established master sequence.

5. The method of claim 1, further comprising:
providing the ability to store a secondary identification sequence in the memory using the keypad; and
providing the ability to store a secondary unique identifying feature in the memory using the biometric sensor, wherein the locking mechanism is unlocked by one of:
providing a second identifying feature using the biometric sensor that matches the secondary unique identifying feature, and if access to the interior compartment is denied after providing the second identifying feature, allowing the locking mechanism to be unlocked by entering a second input sequence using the keypad that matches the secondary identification sequence.

6. The method of claim 5, wherein the secondary identification sequence is a five digit number.

7. The method of claim 5, wherein at least one of the secondary identification sequence and the secondary unique identifying feature are allowed to be stored in the memory after at least one of:
a first input sequence is provided using the keypad that matches the primary identification sequence; and
a first identifying feature is provided using the biometric sensor that matches the primary unique identifying feature.

8. The method of claim 5, further comprising the step of deleting the secondary identification sequence and the secondary unique identifying feature that are stored in the memory by entering the pre-established master sequence using the keypad.

9. The method of claim 1, further comprising the step of deleting the primary identification sequence and the primary unique identifying feature that are stored in the memory by entering the pre-established master sequence using the keypad.

10. The method of claim 1, wherein the enclosure includes a key lock, and wherein the locking mechanism is unlocked only if the key lock is in an unlocked position.

11. The method of claim 1, wherein at least one of the first input sequence or the first identification feature are stored in memory.

12. A method for accessing an interior compartment of an enclosure, wherein the enclosure includes a locking mechanism for locking and unlocking a door of the enclosure, a biometric sensor, a keypad, and a memory, the method comprising:
providing a pre-established master sequence stored in the memory;
storing a primary identification sequence in the memory using the keypad; and
storing a primary unique identifying feature in the memory using the biometric sensor, wherein the locking mechanism is unlocked by
providing a first identifying feature using the biometric sensor that matches the primary unique identifying feature, and if access to the interior compartment is denied after providing the first identifying feature, allowing the locking mechanism to be unlocked by entering a first input sequence using the keypad that matches the primary identification sequence.

13. The method of claim 12, wherein the biometric sensor and keypad are mounted to a door of the enclosure.

14. The method of claim 12, wherein the primary identification sequence is a five digit number.

15. The method of claim 12, wherein the pre-established master sequence is securely maintained by a third-party, and wherein a primary user is provided access to the pre-established master sequence.

16. The method of claim 12, further providing:
storing a secondary identification sequence in the memory using the keypad; and
storing a secondary unique identifying feature in the memory using the biometric sensor, wherein the locking mechanism is unlocked by
providing a second identifying feature using the biometric sensor that matches the secondary unique identifying feature and if access to the interior compartment is denied after providing the second identifying feature, allowing the locking mechanism to be unlocked by entering a second input sequence using the keypad that matches the secondary identification sequence.

17. The method of claim 16, wherein the secondary identification sequence is a five digit number.

18. The method of claim 16, wherein at least one of the secondary identification sequence and the secondary unique identifying feature are allowed to be stored in the memory after at least one of:
a first input sequence is provided using the keypad that matches the primary identification sequence; and
a first identifying feature is provided using the biometric sensor that matches the primary unique identifying feature.

19. The method of claim 16, further comprising the step of deleting the secondary identification sequence and the secondary unique identifying feature from the memory by entering the pre-established master sequence using the keypad.

20. The method of claim 12, further comprising the step of deleting the primary identification sequence and the primary unique identifying feature from the memory by entering the pre-established master sequence using the keypad.

21. The method of claim 12, wherein the enclosure includes a key lock, and wherein the locking mechanism is unlocked only if the key lock is in an unlocked position.

22. The method of claim 12, further comprising the step of storing at least one of the first input sequence and the first identifying feature in the memory.

23. A system for administering access to an interior compartment of an enclosure, the enclosure including a door, the system comprising:
a locking mechanism operative to lock and unlock the door of the enclosure;
a keypad operative to allow a primary identification sequence and a first input sequence to be entered into the system;
a biometric sensor operative to allow a primary unique identifying feature and a first identifying feature to be entered into the system;
a storage device; and
a processor programmed to:
maintain in the storage device a pre-established master sequence, the primary identification sequence, and the primary unique identifying feature,
compare the first input sequence with the primary identification sequence,
compare the first identifying feature with the primary unique identifying feature,
unlock the locking mechanism if the first input sequence matches the primary identification sequence, and
unlock the locking mechanism if the first identifying feature matches the primary unique identifying feature.

24. The system of claim 23, further comprising a key lock, and wherein the locking mechanism is unlocked only if the key lock is in an unlocked position.

25. The system of claim 23, wherein at least one of the first input sequence or the first identifying feature are stored in the storage device.

26. A computer-readable medium having computer-executable instructions for performing a method comprising:
maintaining in a memory a pre-established master sequence, a primary identification sequence, and a primary unique identifying feature, wherein the primary identification sequence is established using a keypad, and wherein the primary unique identifying feature is established using a biometric sensor;
comparing a first input sequence with the primary identification sequence, wherein the first input sequence is entered using the keypad;
comparing a first identifying feature with the primary unique identifying feature, wherein the first identifying feature is entered using the biometric sensor;
unlocking the locking mechanism if the first input sequence matches the primary identification sequence, and
unlocking the locking mechanism if the first identifying feature matches the primary unique identifying feature.
